(19) United States
(12) Patent Application Publication
(10) Pub. No.: US 2010/0111538 A1
(43) Pub. Date: May 6, 2010

(54) ILLUMINATING LIGHT COMMUNICATION DEVICE

(76) Inventors: Takemi Arita, Tokyo (JP); Shinichiro Haruyama, Tokyo (JP); Masao Nakagawa, Kanagawa (JP); Takehiko Yamaguchi, Kanagawa (JP); Toshihiko komine, Shizuoka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 12/225,794

(22) PCT Filed: Mar. 30, 2007
(86) PCT No.: PCT/JP2007/057082

§ 371 Date: Jan. 13, 2010

(30) Foreign Application Priority Data
Mar. 31, 2006 (JP) 2006-100165

(51) Int. Cl. H04B 10/00

(52) U.S. Cl. 398/130

(57) ABSTRACT

An illuminating light communication device, which is for establishing a communication system capable of controlling fluctuation in intensity of illuminating light when transmitting data using a power line and illuminating light, and satisfactorily carrying out communication using the power line and communication using the illuminating light, is provided. When data is transmitted through the power line, a signal component is extracted by a filter unit 12, and the demodulated by a power line modulator-demodulator 13, thereby retrieving the data. The retrieved data is temporarily stored in a protocol converter 14. Afterward, the data is converted to the optical communication protocol, and blinking or amount of light of a semiconductor light emitting element 16 is controlled according to the data transmitted from a light source control unit 15, thereby modulating the illuminating light. This allows transmission of data utilizing the illuminating light. Multiple-valued PPM, which defines that existing pulses correspond to OFF while no pulse corresponds to ON, may be used as a modulation system for optical communication.

### TECHNICAL FIELD

The present invention relates to a communication service of transmitting data using a power line and illuminating light (visible light).

### BACKGROUND ART

In recent years, semiconductor light emitting elements such as LEDs have been used as a light source for illumination. Controlling blinking or amount of light of the semiconductor light emitting elements at a high speed is possible. Use of this characteristic to control the blinking or amount of light of the semiconductor light emitting elements for illumination according to data has allowed development of technology for transmitting data using illuminating light. If blinking or change in amount of light of a semiconductor light emitting element is fast, that blinking or change in amount of light is undetectable by the human eye. As a result, transmission of data may be performed without impeding use as illuminating light for humans. Moreover, lighting devices are widely and generally used, and there is a merit that these lighting devices may be used for communication.

In the general case of transmitting data, a data line exclusive to data is provided separately from a power line. However, since the lighting device is typically connected to the power line and receives a supply of electric power therefrom, supplying the data to the lighting device using the power line is considered. Even if data is transmitted via a power line when an already installed lighting device is substituted with an illuminating light communication device capable of data transmission using illuminating light, installation costs may be reduced drastically since laying a data line separately is unnecessary. Such a conventional communication system is disclosed in Patent Document 1, for example, which describes a system of transmitting data to an illuminating light communication device using a power line, modulating illuminating light according to data received by the illuminating light communication device, and superimposing the data on the illuminating light and transmitting it.

On the other hand, in the case of illuminating, unchangeable brightness is a prerequisite. However, while the modulation system used for data transmission using a power line is appropriate for transmission using a power line, illuminating light is not considered in any way. Therefore, when modulating illuminating light as it is by data that has been transmitted via a power line as described in Patent Document 1, there was a problem that the optical intensity of the illuminating light changes due to the data. More specifically, the power line is easily affected by noise or the like, which generates flickering of the illuminating light.

Moreover, since typical power-line communication provides a unique environment generating noise depending on the power supply frequency, OFDMA or CSMA is utilized as a communication method in the MAC layer while avoiding the method of transmitting signals at constant timings. Such method is not always appropriate for illuminating light communication.

Furthermore, transmission speed is constant in both directions in typical power-line communication. However, when using illuminating light for communication, while broadband communication technique may be used for data transmission (downlink) from an illuminating light communication device to each terminal, an infrared data communication technique is typical for data transmission (uplink) from each terminal, and transmission speed is slower than on the uplink. As such, communication using illuminating light is often carried out at an asymmetrical transmission speed, and there is a problem in this connection in carrying out power-line communication and illuminating light communication using the same protocol.

Patent Document 1: Japanese Unexamined Patent Application Publication No. 2004-147063

### DISCLOSURE OF INVENTION

### [Problems to be Solved by the Invention]

The present invention is devised through consideration of the aforementioned actual condition. An objective thereof is to provide an illuminating light communication device, which is for establishing a communication system capable of controlling fluctuation in intensity of illuminating light when transmitting data using a power line and illuminating light (visual light), and satisfactorily carrying out communication using the power line and communication using the illuminating light.

### [Means of Solving the Problems]

An aspect of the present invention is characterized by an illuminating light communication device, which is supplied with an electric power from a power line and illuminates. This device includes: a semiconductor light emitter, which emits illuminating light; a power line demodulator, which demodulates a signal component transmitted through a power line to retrieve data; a protocol converter, which converts between a protocol of communicating through the power line and a protocol of communicating via illuminating light; and an optical modulator, which controls blinking or amount of light of the semiconductor light emitter according to the data transmitted via the illuminating light and modulates the illuminating light according to the data.

Multiple-valued PPM, which defines that existing pulses correspond to OFF while no pulse corresponds to ON, may be used as a modulation system for the protocol of carrying out illuminating light communication, which is converted by the protocol converter.

### [Effects of Invention]

According to the present invention, by converting the protocol of power-line communication to an optimum protocol for illuminating light communication, illuminating light communication may be carried out without decreasing the performance of illuminating. By using multiple-valued PPM, which defines that existing pulses correspond to OFF while no pulse corresponds to ON, as a modulation system for the protocol of carrying out illuminating light communication, for example, the case of no pulse provides typical illuminating light while case of an existing pulse provides a mere fraction of the time of not lighting. Therefore, communication is possible without much decrease in amount of illumination and with control of fluctuation in amount of light.

### BRIEF DESCRIPTION OF DRAWINGS

FIG. 1 is a block diagram showing an exemplary communication system including an embodiment of the present invention; and

FIG. 2 is an explanatory diagram of an exemplary modulation system for an optical communication protocol.

### DESCRIPTION OF REFERENCE NUMERALS

11 . . . AC-to-DC converter, 12 . . . filter unit, 13 . . . power line modulator-demodulator, 14 . . . protocol converter, 15 . . . light source control unit, 16 . . . semiconductor light emitting element, 17 . . . light receiving element, 18 . . . optical demodulator, 21 . . . receiver, 22 . . . light receiving element, 23 . . . optical modulator-demodulator, and 24 . . . semiconductor light emitting element.

### BEST MODE FOR CARRYING OUT THE INVENTION

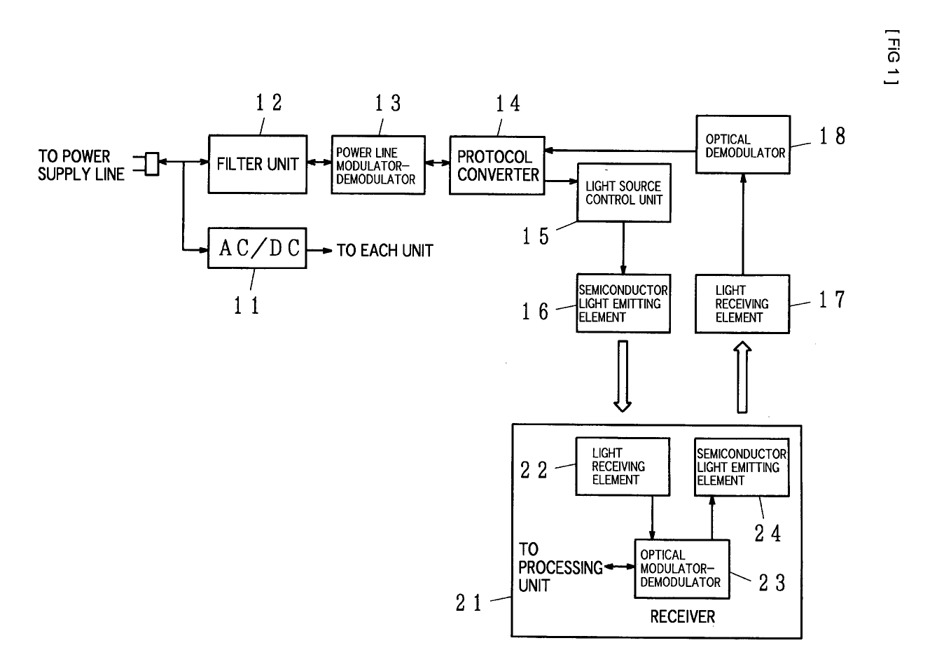

FIG. 1 is a block diagram showing an exemplary communication system including an embodiment of the present invention. In this drawing, 11 denotes an AC-to-DC converter, 12 denotes a filter unit, 13 denotes a power line modulator-demodulator, 14 denotes a protocol converter, 15 denotes a light source control unit, 16 denotes a semiconductor light emitting element, 17 denotes a light receiving element, 18 denotes an optical demodulator, 21 denotes a receiver, 22 denotes a light receiving element, 23 denotes an optical modulator-demodulator, and 24 denotes a semiconductor light emitting element.

In the structure given in FIG. 1, the illuminating light communication device of the present invention is constituted by the AC-to-DC converter 11, the filter unit 12, the power line modulator-demodulator 13, the protocol converter 14, the light source control unit 15, the semiconductor light emitting element 16, the light receiving element 17, and the optical demodulator 18. The AC-to-DC converter 11 converts alternating current which is supplied via a power line to direct current, and supplies electric power to each unit.

The filter unit 12 extracts high-frequency components, which are signal components transmitted through the power line.

The power line modulator-demodulator 13 demodulates the signal component transmitted through the power line to retrieve the original data. Moreover, it modulates data to be transmitted according to a modulation system for power-line communication and then transmits the modulated signals through the power line.

The protocol converter 14 converts between a power-line communication protocol (modulation system included) for communication through a power line and an optical communication protocol (modulation system included) for communication through light such as illuminating light or the like. More specifically, once it has received data transmitted using the power-line communication protocol through the power line and temporarily stored it, it transmits that data to the light source control unit 15 according to the optical communication protocol. Moreover, once it has temporarily stored the data received using the optical communication protocol, it transmits that data to the power line via the power line modulator-demodulator 13 using the power-line communication protocol.

The light source control unit 15 controls blinking or amount of light of the semiconductor light emitting element 16 according to data for transmission using the optical communication protocol converted by the protocol converter 14. The illuminating light has been modulated according to the data.

The semiconductor light emitting element 16 emits light using DC power supplied from the AC-to-DC converter 11. This emitted light is used as illuminating light. Various semiconductor light emitting elements such as LED, LD, EL, or the like, for example, may be used. Moreover, the semiconductor light emitting element 16 is controlled to change blinking or amount of light by the light source control unit 15, thereby modulating the illuminating light according to the data.

The light receiving element 17 receives an optical signal transmitted from the receiver 21. Moreover, the optical demodulator 18 demodulates the optical signal received by the light receiving element 17, thereby retrieving the data transmitted from the receiver 21.

The receiver 21 communicates with the illuminating light communication device of the present invention using visible light, and is constituted, in this example, by the light receiving element 22, the optical modulator-demodulator 23, and the semiconductor light emitting element 24. The light receiving element 22 receives illuminating light modulated according to the data from the illuminating light communication device of the present invention. The light demodulator 23 demodulates the modulated illuminating light signal received by the light receiving element 22 and retrieves the data transmitted via the illuminating light. Moreover, it modulates the data to be transmitted to the illuminating light communication device. The semiconductor light emitting element 24 emits a controlled blinking light or a controlled amount of light in conformity with the data modulated by the light demodulator 23. Various semiconductor light emitting elements such as LED, LD, EL, or the like, for example, may also be used as the semiconductor light emitting element 24.

Next, an outline of operations of such an exemplary communication system including the embodiment of the present invention is briefly explained. In a normal state, AC power supplied from a power line is converted to DC power by the AC-to-DC converter 11 and supplied to the semiconductor light emitting element 16. The semiconductor light emitting element 16 may be supplied with electric power to emit light, and use this emitted light for illumination.

When data is transmitted through a power line, a signal component is then extracted by the filter unit 12, and data is demodulated and retrieved by the power line modulator-demodulator 13. The retrieved data is temporarily stored in the protocol converter 14. Afterward, it is converted to the optical communication protocol, and blinking or amount of light of the semiconductor light emitting element 16 is controlled according to the data transmitted from the light source control unit 15, thereby modulating the illuminating light. This allows transmission of data utilizing the illuminating light. Conversion of protocol including this modulation system also allows conversion of transmission speed of power-line communication and illuminating light communication, timing control, or the like.

OFDMA or CSMA is utilized as a communication method in the MAC layer, for example, in the aforementioned manner for power-line communication. With the present invention, instead of relaying to this power-line communication protocol as the optical communication protocol, it is converted to an optical communication protocol optimum particularly when using illuminating light, and the illuminating light is modulated according to the data and then transmitted.

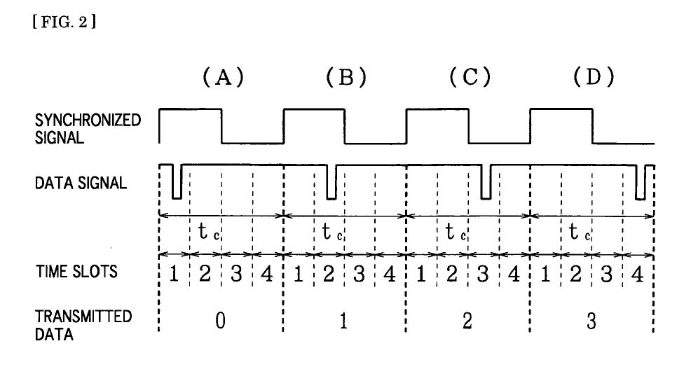

FIG. 2 is an explanatory diagram of an exemplary modulation system for an optical communication protocol. Multiple-valued PPM, which defines that existing pulses correspond to OFF while no pulse corresponds to ON, may be used as an exemplary modulation system for the protocol of carrying out illuminating light communication. For example, FIG. 2 shows a case of 4-valued PPM. This system gives values for data according to pulse positions. In FIG. 2(A) to (D), for example, values are determined according to the position set to OFF of one of four pulse positions divided by dashed lines in the drawing. FIG. 2(A) to (D) correspond to data values 0 to 3, respectively.

With the modulation system as in this example, the period to be OFF is ¼ of the entirety at most. Such OFF period cannot be detected by the human eye when communication speed is fast, nor can humans sense any flicker at all. The average amount of light decreases slightly but is only ¼ or less. As such, transmission of data using illuminating light is possible without losing the function as illuminating light. Of course, while it is not limited to such modulation system, protocol conversion allows selection and use of an optimum protocol for illuminating light communication.

The receiver 21 may receive the illuminating light modulated by the data. Namely, the light receiving element 22 receives illuminating light from the semiconductor light emitting element 16 of the illuminating light communication device, and the light demodulator 23 demodulates it, thereby allowing reception of data transmitted from the illuminating light communication device using illuminating light.

The receiver 21 transmits the data by the optical modulation unit 23 modulating the data first and then controlling blinking or amount of light of the semiconductor light emitting element 24 in conformity with the data. The modulated light is irradiated as a result. In this case, the semiconductor light emitting element 24 merely needs to be able to transmit data via light without illuminating.

The light irradiated from the semiconductor light emitting element 24 of the receiver 21 is received by the light receiving element of the illuminating light communication device and then demodulated by the optical demodulator 18. Once the light is temporarily stored in the protocol converter 14, it is converted to the power-line communication protocol and then transmitted to the power line. Even in this case, the optimum power-line protocol may be used and conversion of communication speed and control of timings may be performed.

As such, light is used in this example not only for data transmission from the illuminating light communication device to the receiver 21 but also for data transmission from the receiver 21 to the illuminating light communication device. This allows communication by light in both directions. Even if the receiver 21 is a portable terminal, for example, wireless communication is possible. Other than visible light, infrared light, for example, may be used of course on the uplink. Alternatively, when connected to a power line as with a stationary terminal or the like, an uplink may be established through the power line. Even in this case, the utilization advantage is great such as use of illuminating light on the downlink allowing distribution of the same data to multiple receivers 21.

Note that although there are cases where the transmission speed is typically slower on the uplink than on the downlink and different from the power-line communication speed, the change in these communication speeds may be eliminated by temporarily storing the data in the protocol converter 14. Moreover, repeated transmission of the same data is possible by utilizing temporary storage of data in the protocol converter 14.

All the elements shown in FIG. 1 may be integrated into a single device, or the configuration excluding the semiconductor light emitting element 16 or excluding the semiconductor light emitting element 16 and the light receiving element 17 may be integrated into a single device as a lighting apparatus. Alternatively, it may be miniaturized to have the shape of an electric bulb or tube shape, which may be loaded in lighting apparatus instead of an electric bulb or fluorescent tube already loaded in a typically used lighting apparatus. Such configurations may be used easily, and may allow suppression of installation costs since changing the lighting apparatus is unnecessary. Alternatively, various already existing lighting apparatus may be used as is.

1. An illuminating light communication device, comprising: a semiconductor light emitter, which emits illuminating light; a power line demodulator, which demodulates a signal component transmitted through a power line to retrieve data; a protocol convertor, which converts between a protocol of carrying out power-line communication and a protocol of carrying out illuminating light communication; and an optical modulator, which controls blinking or amount of light of the semiconductor light emitter according to the data transmitted via the illuminating light and modulates the illuminating light according to the data.

2. The illuminating light communication device of claim 1, wherein the protocol convertor uses multiple-valued PPM, which defines that existing pulses correspond to OFF while no pulse corresponds to ON, as a modulation system for the protocol of carrying out illuminating light communication.
